(19) United States
(12) Patent Application Publication
(10) Pub. No.: US 2014/0213365 A1
(43) Pub. Date: Jul. 31, 2014

(54) GUN-SHAPED GAME INPUT HANDLE OF MULTI-FUNCTIONAL MOBILE ELECTRONIC DEVICE

(71) Applicant: Siming Cao, Nanchang (CN)

(72) Inventor: Siming Cao, Nanchang (CN)

(21) Appl. No.: 14/347,571

(22) PCT Filed: Sep. 7, 2012
(86) PCT No.: PCT/CN2012/081143

§ 371 Date: Mar. 26, 2014

(30) Foreign Application Priority Data
Sep. 29, 2011 (CN) 201120366743.2
May 9, 2012 (CN) 201210140007.4

(51) Int. Cl. A63F 13/20

(52) U.S. Cl. CPC A63F 13/06
USPC 463/37

(57) ABSTRACT

The present invention claims a gun-shaped game input handle of a multi-functional mobile electronic device comprising a gun-shaped housing, wherein it further comprises buttons and a direction control joystick fixed to the gun-shaped housing and used to control the actions and movements of a virtual character in a mobile electronic device game, a main control circuit built in the gun-shaped housing, and a data interface for communicating with the mobile electronic device; the data interface transmits signals to the mobile electronic device in wired or wireless way. The shape of the handle is similar to that of a gun, thus meeting the special game input requirements of First-Person Shooter games, and improving game operation verisimilitude.

### FIELD OF THE INVENTION

The present invention relates to a multi-shaft input device, belonging to technical field of control input of mobile electronic device, specifically to a gun-shaped input handle of mobile electronic device.

### BACKGROUND OF THE INVENTION

Along with continuous development of electronic virtual technology, the electronic game device needs to be updated continuously. Appearance of new game types requires new game input devices to meet different requirements. For example, after appearance of racing games, the input device in the shape of steering wheel is developed, and some even being equipped with input handle device like foot treadle and speed variator; and flying joystick type input handle came after the appearance of the flying simulation type games. The mobile electronic device has been a mature game platform now, but operation of the traditional input device for mobile electronic device is realized by pressing buttons on the mobile electronic device or by touching the screen thereof. Aiming and movement of the virtual character holding a gun in the game are controlled by using gravity sensor, gyroscope chip, buttons or touch screen on the mobile electronic device, including operations like left and right movement, upward and downward movement, actions of the virtual character (going forward, backward, moving left and right), jumping, squatting, and changing virtual gun in the game.

At present, there is not control handle used for game on the mobile electronic device on the market. Because of design limitation of the mobile electronic device, the player cannot have good experience of playing games on the mobile electronic device. The present invention aims at solving the problem that it is difficult to operate and control while playing shooting games on the mobile electronic device, so that the player can get better and more vivid operation experience while playing shooting games on the mobile electronic device.

### SUMMARY OF THE INVENTION

In order to solve the above problem, the handle is in the shape similar to the real gun, and the player can operate and finish the operations like shooting and changing box magazine in the game.

The present invention comprises a housing with a gun-shaped main frame, and multiple functional buttons provided on the housing, as well as a main control circuit in the housing; and the main control circuit is provided with a signal transmitter and a signal receiver, the signal transmitter is in data transmission connection with the signal receiver in a wired or wireless way, and the signal receiver is in data transmission connection with the mobile electronic device in a wired or wireless way.

The functional buttons are used to finish operations of virtual character in the game, such as firing, jumping, squatting and using virtual objects in game, and the direction control joystick is used to control actions of virtual character in game; shape and distribution of the buttons and joystick can be designed according to actual operation requirement; the gyroscope chip is used to locate movement of the electronic device and the handle to realize aiming and locating operations in game, and the principle is the same as that of the built-in gyroscope chip of the electronic device on the market. Because moving the handle left, right, upwards and downwards can finish the above movements, the signal transmitted by the gyroscope chip can reflect the movement of handle; the signal can be used to control movement of the virtual gun in game, and to control character in game to look upwards, downwards, left and right. Because some mobile electronic devices on the market have built-in gyroscope chip, arrangement of the built-in gyroscope chip in the handle is determined according to actual requirement.

The output signal of buttons, and signal generated by or received from gyroscope chip unit and sound effect loudspeaker are received by the signal receiver of the main control circuit, and the transmitted signal is transferred to the mobile electronic device by the signal transmitter of the main control circuit through the communication interface in a wired or wireless way.

The present invention aims at providing a gun-shaped game input handle of multi-functional mobile electronic device, so as to overcome the above defects of the existing products, such that the player can control movement of character in the mobile electronic device games better and experience operation and shooting in the game more vividly.

Based on the above proposal:

The buttons include a firing button, a direction control joystick and multiple functional buttons; the direction control joystick is arranged on the handle of the gun-shaped housing at the position corresponding to natural contact position of right thumb, used for movement operation of the virtual character towards four directions in game; shape or operation of the firing button is similar to that of trigger, being arranged at a proper position such that the player can operate it in a way similar to operating a real gun; the firing button is used for firing operation of the virtual gun in game. The functional buttons are arranged on the gun-shaped housing at proper positions based on requirement of game software and operation convenience of player, such that the player can finish the operations required in the game conveniently; the functional buttons are used for operations like running and changing guns in the game.

The mobile electronic device can be smart phone, feature phone, tablet personal computer or any existing mobile electronic devices capable of running games, and the communication way is various data interfaces of the mobile electronic device or any known communication way that can be used for the input handle.

The way of using the present invention is as follows:

Combining and fixing the present invention and the mobile electronic device together, connecting the signal wire of the present invention (or wireless signal receiver) to the mobile electronic device through the interface, turning on the mobile electronic device, and turning it such that screen of the mobile electronic device is in an angle of 90 degrees to the gun-shaped handle of the present invention.

After entering game, the player moves screen of the mobile electronic device (or monitor) to the front, and holds the handle as holding a gun with one hand; when the player needs to aim at the virtual target on the screen (or monitor), based on the principle of gyroscope chip, the player only needs to finish the displacement operation of the handle upwards or downwards, to the left or right, so as to aim at the virtual target on the screen (or monitor). When the player needs to fire after aiming at the virtual target, the player only needs to pull the trigger of the handle with finger, the virtual gun in game will fire at the same time.

When the virtual gun in game is out of bullet or it is necessary to change the box magazine, the player needs to press the box magazine changing button on the handle, then loading operation of the virtual gun in game is finished accordingly.

When the virtual character in game needs to finish some actions, for example, moving, running and jumping, the player can operate or press the joystick or functional buttons on the handle accordingly.

The gun-shaped input handle of the present invention provides a new real and natural operation way for the First-Person shooting game on the mobile electronic device, with improved operability and sense of reality.

### BRIEF DESCRIPTION OF THE DRAWINGS

FIG. 1 is the main view structure diagram of embodiment of the present invention;

FIG. 2 is the back structure diagram of embodiment of the present invention;

FIG. 3 is the main view structure diagram in gaming state of embodiment of the present invention;

FIG. 4 is the back structure diagram in gaming state of embodiment of the present invention; and

FIG. 5 is inner structure diagram of embodiment of the present invention.

### DETAILED DESCRIPTION OF THE PREFERRED EMBODIMENTS

The following is detailed description of implementing the present invention in combination with drawings.

The gun-shaped game input handle of a multi-functional mobile electronic device of the present invention comprises a housing with a gun-shaped main frame, multiple buttons provided on the housing, a main control circuit in the housing, an enclosure housing capable of fixing the mobile electronic device, a rotating bearing that can be connected with the enclosure housing of the mobile electronic device and rotate for 90 degrees, a retractable bracket, and interfaces used for communication with the mobile electronic device running the game program; the functional buttons and the direction control joystick are used to control actions and movements of the virtual character in game, and the gyroscope chip is used to control movement of visual angle of the virtual character in game; the signal generated by or received from the above functions is transmitted or fed to the mobile electronic device in a wired or wireless way after being treated by the signal transmitter and signal receiver.

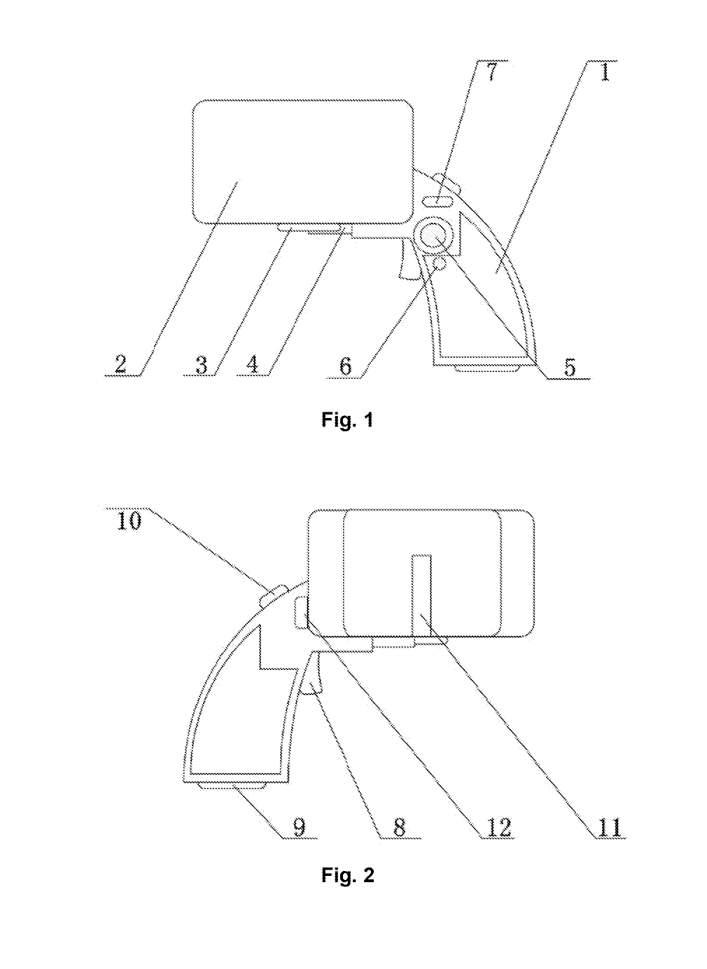

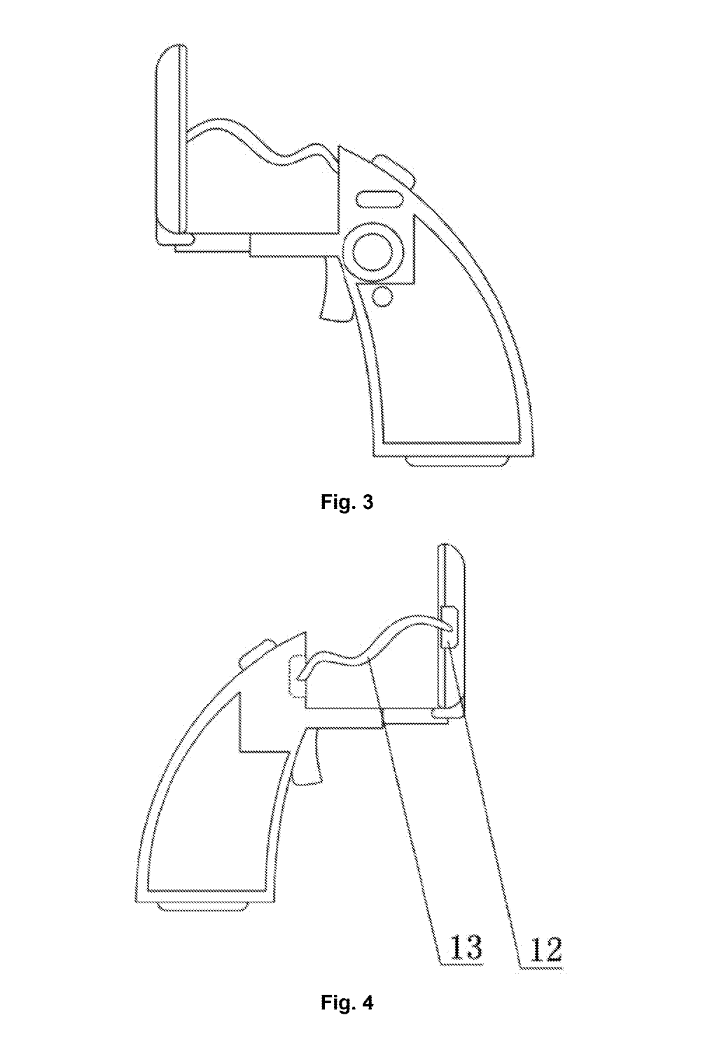

At first, as shown in FIG. 1 and FIG. 2, in the embodiment, basic structure of the present invention is in the shape of gun. The present invention comprises a gun-shaped housing 1, a trigger 8 is used for firing operation of the virtual gun in game; while operating, the right thumb (inverse for the left-handed people, the same hereinafter) of the player is on placed on the trigger 8, so as to finish the firing operation of the virtual gun in game by pull the trigger 8; the direction control joystick 5 is used to control upward or downward, left or right movement of the virtual character; the direction control joystick 5 is at the upper left of the grip, operated by the left thumb; the first functional button 9 is arranged at lower part of the grip, operated by the left hand, corresponding to the running and walking switchover operation of the virtual character in game; the second functional button 10 is arranged at upper part of the grip, operated by right thumb or left hand, corresponding to the operation of switching visual angle of shooting; principle of the roller 7 is the same as that of mouse wheel, arranged above the direction control joystick 5 that is to the left of grip, operated by right thumb, corresponding to changing gun or other operations in game; the box magazine release button 6 is arranged under the direction control joystick 5 that is to the left of grip, operated by right thumb, corresponding to box magazine release or loading operation of the virtual gun in game.

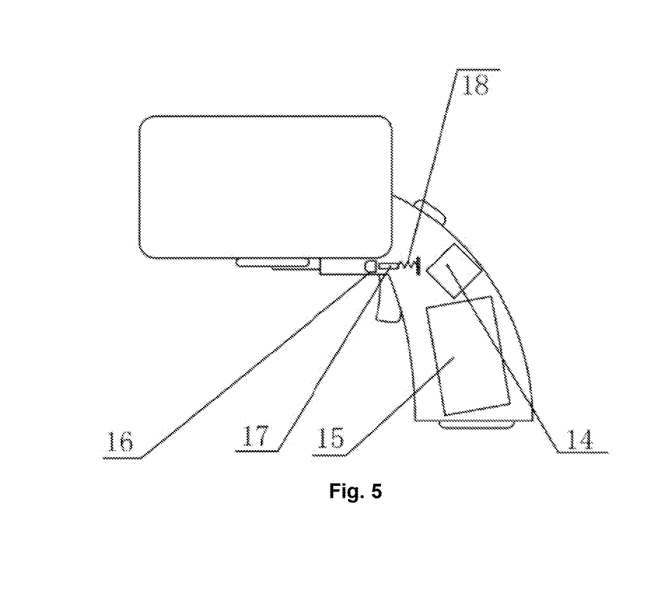

The internal structure of the handle is as shown in FIG. 5. A gyroscope chip 14, a main control circuit 15, a trigger contact switch 16, a trigger hinged shaft 17, a trigger reset spring 18; the main control circuit 15 is used to control receiving and transmitting of optoelectronic signal, and control the direction control joystick 5, the first functional button 9, the second functional button 10 and the roller 7 to trigger the circuit. The trigger 8 is triggered through contact with the trigger contact switch 16 after being rotated by the trigger hinged shaft 17, and reset by the pulling force of the trigger reset spring 18.

The data interface 12 and data cable 13 are the media of the handle with the mobile electronic device; one end of the data cable 13 is connected with the circuit board inside the handle, and the other end is connected with the data interface 12. After being connected with the data interface of the mobile electronic device, data exchange between the data interface 12 and the mobile electronic device is realized. Because there are many different mobile electronic devices with different data interfaces on the market, the data interface 12 can be designed differently to fit the data interface of the mobile electronic device. The communication way of the handle and the mobile electronic device can be realized through data cable or wireless communication.

The enclosure housing 2 of the mobile electronic device is used to combine and fix the mobile electronic device, similar to the phone shell on the market. Because there are many different kinds of mobile electronic devices on the market, the enclosure housing 2 is a separate unit and can be changed accordingly for different mobile electronic device.

The rotating bearing 3 is connected and integrative with the enclosure housing 2 through the slot on the retractable bracket 4, thus to combine the mobile electronic device with the handle. The rotating bearing 3 can be rotated for 90 degrees, so the screen of the mobile electronic device can be in a 90 degree angle with the handle, which is convenient for the user to play games.

The back reinforcement plate 11 is integrative with the rotating bearing 3, being used for supporting the mobile electronic device after the mobile electronic device is rotated for 90 degrees.

The retractable bracket 4 can be extended or shortened. The mobile electronic devices on the market are different in size and shape, and the user can adjust length of the retractable bracket 4 conveniently through the retractable rod 4.

For the gun-shaped housing in other shapes, the arrangement of control buttons and basic internal structure are similar to the above description, and can be adjusted according to actual requirement.

To sum up, the above embodiment is only one of the implementation ways of the present invention, but not restriction to the present invention. All equivalent structures or equivalent process transformation with similar structure and design thought, and same or similar technical effects based on the specification and drawings of the present invention shall belong to the protective scope of the present invention.

What is claimed is:

1. A gun-shaped game input handle of multi-functional mobile electronic device, comprising a housing, multiple buttons provided on the housing and a main control circuit built in the housing, wherein the buttons are electrically connected with the main control circuit; the shape of the main frame thereof is in the shape of a gun; the main control circuit is provided with a signal transmitter that is in data transmission connection with a signal receiver in a wired or wireless way, and the signal receiver is in data transmission connection with the mobile electronic device in a wired or wireless way.

2. The gun-shaped game input handle of multi-functional mobile electronic device according to claim 1, wherein the buttons include a trigger-shaped firing button, a functional button and a direction control joystick.

3. The gun-shaped game input handle of multi-functional mobile electronic device according to claim 1, wherein the gun-shaped housing is provided with a handle.

4. The gun-shaped game input handle of multi-functional mobile electronic device according to claim 1, wherein a retractable bracket is provided on the gun-shaped housing.

5. The gun-shaped game input handle of multi-functional mobile electronic device according to claim 4, wherein the retractable bracket is provided with a slot that is used for active connection with a mobile phone housing.
